(19) United States
(12) Patent Application Publication
(10) Pub. No.: US 2025/0138861 A1
(43) Pub. Date: May 1, 2025

(54) VIRTUAL MACHINE POWER CONSUMPTION PREDICTION APPARATUS, VIRTUAL MACHINE POWER CONSUMPTION PREDICTION METHOD, AND PROGRAM

(71) Applicant: NIPPON TELEGRAPH AND TELEPHONE CORPORATION, Tokyo (JP)

(72) Inventors: Yoshikazu NAKAMURA, Tokyo (JP); Shigeaki HARADA, Tokyo (JP); Kosuke SAKATA, Tokyo (JP); Tomonari FUJIMOTO, Tokyo (JP); Motomu NAKAJIMA, Tokyo (JP); Ryo SATO, Tokyo (JP); Yuji SHINOZAKI, Tokyo (JP); Norihiko OBAYASHI, Tokyo (JP)

(21) Appl. No.: 18/835,175

(22) PCT Filed: Feb. 10, 2022
(86) PCT No.: PCT/JP2022/005436

§ 371 Date: Aug. 1, 2024

(51) Int. Cl. G06F 9/455; G06F 9/50

(52) U.S. Cl. CPC G06F 9/45558; G06F 9/5094; G06F 2009/45591

(57) ABSTRACT

A virtual machine power consumption prediction device includes: a power consumption calculation part which calculates power consumption of a virtual machine running on a first server on the basis of a resource usage state on the first server; and a power consumption prediction part which predicts power consumption of the virtual machine when the virtual machine is moved to a second server on the basis of an index indicating energy consumption efficiency of each of the first server and the second server.

### TECHNICAL FIELD

The present invention relates to a technique for predicting the power consumption of a virtual machine running on a server.

### BACKGROUND ART

In recent years, various network services and applications have been provided using virtual machines (hereinafter referred to as “VMs”) running on physical servers (hereinafter referred to as “servers”) in a plurality of locations (for example, data centers).

In addition, in order to reduce electricity purchasing costs and decarbonize, each site receives the supply of power from two systems such as that of renewable energy generation such as solar power generation and commercial power supplied by a power company in many cases.

In renewable energy power generation, the amount of electricity supplied fluctuates from moment to moment. For this reason, for example, the renewable energy at site B can be used without waste and the electricity purchase fee from the power company at site A can be reduced by moving the VM of the site A to the site B which has surplus renewable energy supply during times at which the renewable energy supply at the site A is decreasing.

### CITATION LIST

### Non Patent Literature

NPL 1: Pape, C., Rieger, S., & Richter, H. (2016). Leveraging Renewable Energies in Distributed Private Clouds. In MATEC Web of Conferences (Vol. 68, p. 14008). EDP Sciences.

### SUMMARY OF INVENTION

### Technical Problem

As described above, it is possible to increase the utilization rate of renewable energy by moving VMs to servers at locations with sufficient renewable energy supply. For this reason, it is necessary to appropriately predict how much power a VM which is moved from the movement source server to the movement destination server will consume on the movement destination server.

The present invention was made in view of the above points, and an object of the present invention is to provide a technique for appropriately predicting power consumption of a virtual machine to be moved from a movement source server to a movement destination server.

### Solution to Problem

According to the disclosed technique, a virtual machine power consumption prediction device including: a power consumption calculation part which calculates a power consumption of a virtual machine running on a first server on the basis of a resource usage state on a first server; and a power consumption prediction part which predicts a power consumption of the virtual machine when the virtual machine is moved to a second server on the basis of an index indicating an energy consumption efficiency of each of the first server and the second server is provided.

### Advantageous Effects of Invention

According to the disclosed technique, it is possible to appropriately predict the power consumption of a virtual machine to be moved from a movement source server to a movement destination server.

### BRIEF DESCRIPTION OF DRAWINGS

FIG. 1 is an overall configuration diagram of a system according to an embodiment of the present invention.

FIG. 2 is a diagram for explaining an overview of the embodiment of the present invention.

FIG. 3 is a flowchart for describing an overall operation.

FIG. 4 is a configuration diagram of a virtual machine power consumption prediction device.

FIG. 5 is a diagram for explaining Example A-1.

FIG. 6 is a diagram for explaining Example A-1.

FIG. 7 is a diagram for explaining Example A-2.

FIG. 8 is a diagram for explaining Example A-3.

FIG. 9 is a diagram for explaining Example B-1.

FIG. 10 is a diagram for explaining Example B-2.

FIG. 11 is a diagram for explaining Example B-2.

FIG. 12 is a diagram for explaining an example in which resources other than a CPU usage rate are also used.

FIG. 13 is a flowchart for describing an overall operation in S2.

FIG. 14 is a diagram for explaining a data accumulation method.

FIG. 15 is a diagram for explaining a data accumulation method.

FIG. 16 is a diagram for explaining a data accumulation method.

FIG. 17 is a diagram for explaining a data accumulation method.

FIG. 18 is a diagram for explaining a data accumulation method.

FIG. 19 is a diagram for explaining a learning/estimation method.

FIG. 20 is a diagram for explaining a prediction method based on macro load trends of a group of VMs of the same type.

FIG. 21 is a diagram for explaining a prediction method based on macro load trends of a group of VMs of the same type.

FIG. 22 is a diagram showing an example of hardware configuration of a device.

### DESCRIPTION OF EMBODIMENTS

An embodiment of the present invention (this embodiment) will be described below with reference to the drawings. The embodiments which will be described below are merely examples and embodiments to which the present invention is applied are not limited to the following embodiments.

### (System Configuration, Operation Overview)

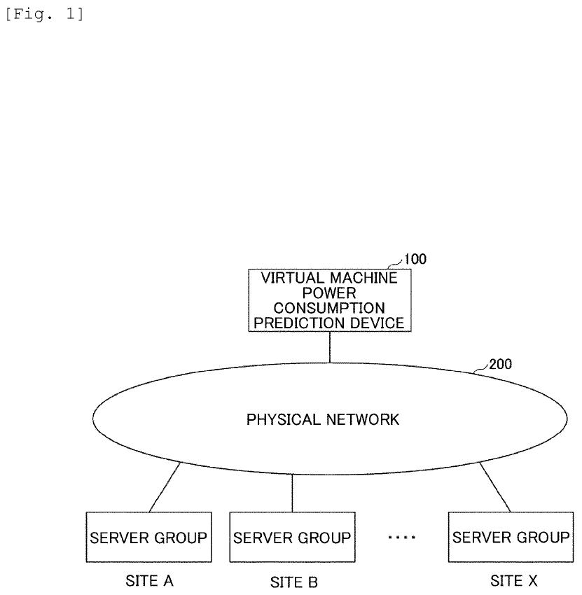

FIG. 1 shows an example of an overall configuration of a system in this embodiment. As shown in FIG. 1, a plurality of locations including server groups are connected to a physical network 200. Furthermore, a virtual machine power consumption prediction device 100 is connected to the physical network 200.

Commercial power from a power company is supplied to each site and power generated using renewable energy is supplied to each site. Note that there may be sites which are supplied only with commercial power supplied from an electric power company or sites which are supplied only with power generated using renewable energy.

Each server at each location has zero or more VMs installed therein. Each VM can be moved between locations using an existing migration technique.

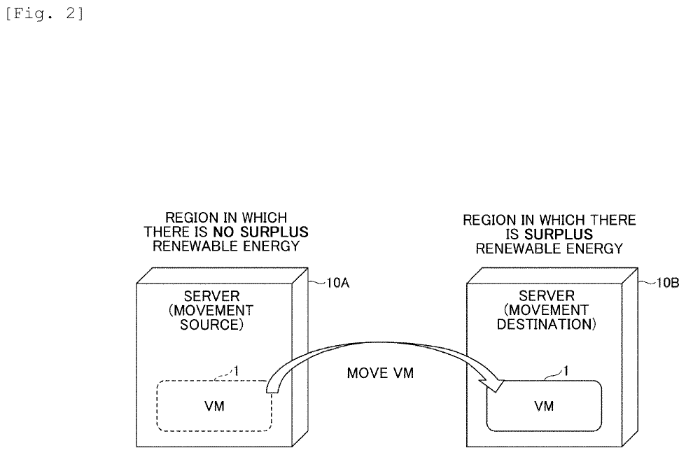

An overview of the processing of the virtual machine power consumption prediction device 100 will be explained with reference to FIG. 2. As shown in FIG. 2, it is assumed that a VM1 is moved from a server 10A in a region in which there is no surplus renewable energy to a server 10B in a region in which there is surplus renewable energy. In order to move the VM1 from the server 10A to the server 10B, it is necessary to predict how much power VM1 will consume in the movement destination server 10B. This is because, if the VM1 consumes too much power relative to the capacity of the server 10B, the operation of the server 10B will be hindered.

In this embodiment, the virtual machine power consumption prediction device 100 performs the above prediction. That is to say, when a VM in the movement source server is moved to a movement destination server, the virtual machine power consumption prediction device 100 predicts the power consumption required by the VM in the movement destination server from the present to the future.

### (Overall Processing Flow, Device Configuration)

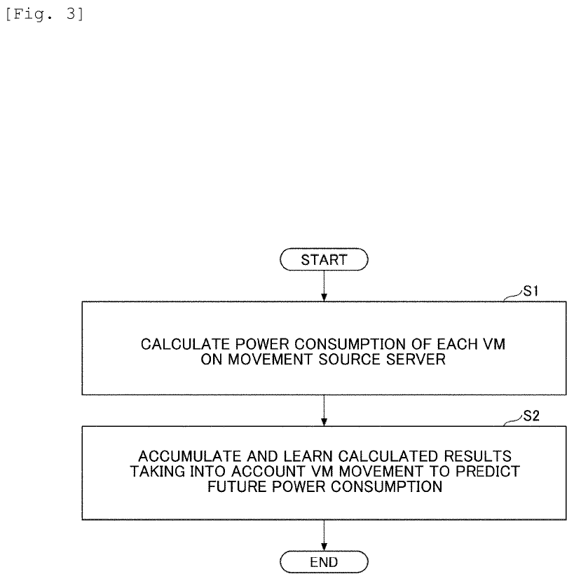

FIG. 3 shows an overall processing flow of the virtual machine power consumption prediction device 100. As shown in FIG. 3, in S1 (Step 1), the virtual machine power consumption prediction device 100 calculates the power consumption of each VM in the movement source server.

In S2, the virtual machine power consumption prediction device 100 converts the power consumption calculated in S1 into the power consumption when the VM is installed in the movement destination server. The results for each server which also includes the calculated values before conversion are accumulated and learning is performed on the basis of the accumulated values to predict a future power consumption.

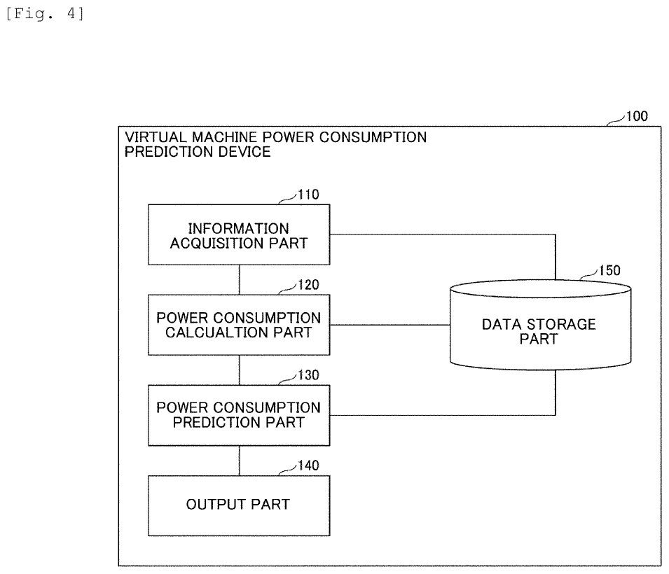

FIG. 4 shows a configuration example of the virtual machine power consumption prediction device 100 which performs the above-described processing. As shown in FIG. 4, the virtual machine power consumption prediction device 100 includes an information acquisition part 110, a power consumption calculation part 120, a power consumption prediction part 130, an output part 140, and a data storage part 150.

The information acquisition part 110 acquires information (resource usage status and the like) necessary for calculating and predicting power consumption from each server. The power consumption calculation part 120 uses the information acquired using the information acquisition part 110 to perform the process of S1 described above. The power consumption prediction part 130 performs the process of S2 described above. The output part 140 outputs the calculation result using the power consumption prediction part 130. The output part 140 may output the calculation result using the power consumption calculation part 120.

The data storage part 150 stores information acquired using the information acquisition part 110, the calculation results using the power consumption calculation part 120, the calculation results using the power consumption prediction part 130, and the like. More specifically, the data stored in the data storage part 150 includes a trend data DB and a host power consumption correction DB which will be described later.

Each of the processes of S1 and S2 will be explained in detail below.

### (S1: VM Power Consumption Calculation Process on Movement Source Server)

First, the VM power consumption calculation process performed using the power consumption calculation part 120 in the movement source server will be described.

### <Overview>

A server having a VM installed therein is composed of a combination of a host OS and a VM. For this reason, the power consumption of this server can be expressed by the following relational expression.

$$Server power consumption = ( power consumption of host OS ) + ( total power consumption of VMs installed in server )$$

For example, if there are the VM1 and the VM2, the total power consumption of VMs installed in a server is (power consumption of the VM1)+(power consumption of the VM2).

In this embodiment, the power consumption calculation part 120 calculates the power consumption of each VM by creating a plurality of relational expressions and solving the plurality of relational expressions. The calculated (estimated) power consumption value is stored in the data storage part 150 as, for example, time series data.

Specifically, a plurality of relational expressions are prepared, the multivariable simultaneous equations are solved, and the power consumption of each VM is calculated by using various resource usage/usage rates such as a CPU usage rate, a memory usage rate, a disk usage rate, and the like. There are Method A and Method B which will be described below, as a method for preparing a plurality of relational expressions.
A) Prepare a plurality of relational expressions for a plurality of servers with the same specifications
B) Prepare a plurality of relational expressions for a plurality of times on the same server Example A for Method A and Example B for Method B will be described below as specific calculation examples. Example A is composed of Example A-1, Example A-2, and Example A-3 and Example B is composed of Example B-1 and Example B-2. Thus, each will be explained.

In Example A and Example B, examples in which only the CPU usage rate is used will be described. An example in which a value other than the CPU usage rate is used will be described as Example C. Note that, although three relational expressions are used as the plurality of relational expressions in the embodiment which will be described below, this is merely an example. Four or more relational expressions may be used. Furthermore, if there are few variables, two relational expressions may be used. In addition, the CPU usage rate and the like are examples of the resource usage rate.

### Example A-1

First, Example A-1 relating to calculating power consumption in a plurality of servers with the same specifications will be described.

It is necessary to define preconditions when calculating power consumption. Here, a simple assumption is made that for VMs of the same type, the CPU usage time (CPU usage rate) and power consumption used using the VMs are linear.

“VMs of the same type” in this embodiment refer to VMs with the same specifications, VMs with the same software, or VMs that perform similar processing. Also, clustered VMs are considered to be of the same type. It is also assumed that the power consumption per 1% CPU usage rate of the host OS is the same for all servers.

Based on these conditions, a plurality of relational expressions are prepared using the CPU usage rates of the host OS and VM and power consumption is calculated.

The information acquisition part 110 acquires the power consumption of the server and the CPU usage rate of the host and each VM from each of the plurality of target servers.

For example, assuming that each server has a VM of type A and a VM of type B, the CPU usage rate of the host is CPU_{HOST}%, the CPU usage rate of VM (type A) is CPU_{A}%, and the CPU usage rate of VM (type B) is CPU_{B}%. Also, the power consumption of the server is defined as P.

Furthermore, assuming that the power consumption per 1% CPU usage rate of the host (example of resource unit usage) is U_{HOST}, the power consumption amount per 1% CPU usage rate of VM (type A) is U_{A}, and the power consumption per 1% CPU usage rate of VM (type B) is U_{B}, the power consumption calculation part 120 creates the following relational expression for each server.

$${CPU}_{HOST} \% \times {U}_{HOST} + {CPU}_{A} \% \times {U}_{A} + {CPU}_{B} \% \times {U}_{B} = P \qquad ( W )$$

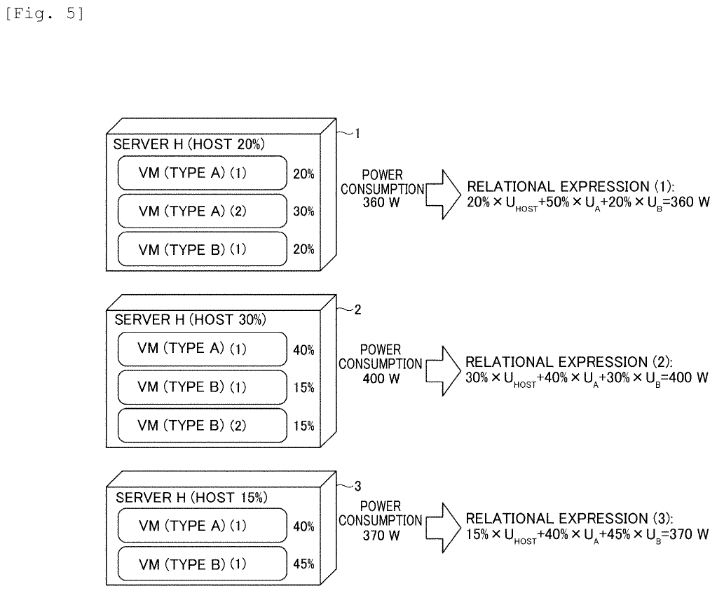

FIG. 5 shows specific examples of three relational expressions when three servers H1 to H3 have, as targets, a plurality of servers with the same specifications. In the state of the servers H1 to H3 shown in FIG. 5, the following three relational expressions are created as shown in FIG. 5.

$$Relational expression ( 1 ) : 20 \% {U}_{HOST} + 50 \% \times {U}_{A} + 20 \% \times {U}_{B} = 360 \qquad ( W )$$

$$Relational expression ( 2 ) : 30 \% {U}_{HOST} + 40 \% \times {U}_{A} + 30 \% \times {U}_{B} = 400 \qquad ( W )$$

$$Relational expression ( 3 ) : 15 \% {U}_{HOST} + 40 \% \times {U}_{A} + 45 \% \times {U}_{B} = 370 \qquad ( W )$$

The power consumption calculation part 120 solves the above three relational expressions as simultaneous expressions to calculate U_{HOST}, U_{A}, and U_{B}.

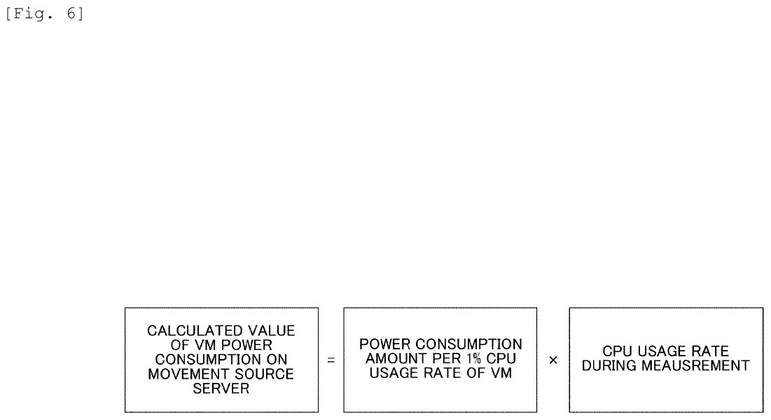

After calculating the power consumption amount per 1% CPU usage rate as described above, the power consumption calculation part 120 calculates the VM power consumption in the movement source server using the following expression as shown in FIG. 6.

$$VM power consumption on movement source server = ( power consumption per 1 \% CPU usage rate of VM ) \times ( CPU usage rate at time of VM measurement )$$

The calculated power consumption is stored in the data storage part 150. The calculation is performed, for example, periodically, and as a result, time-series data is stored in the data storage part 150.

Note that “power consumption per 1% CPU usage rate of VM” may be calculated each time the VM power consumption on the movement source server is obtained or the previously calculated “power consumption per 1% CPU usage rate of VM” may be used for obtaining the VM power consumption on the current migration source server. The same applies when using other resources. In the following examples, differences from Example A-2 will be mainly explained.

### Example A-2

Example A-2 relating to power calculation for a plurality of servers with the same specifications will be described. Example A-2 uses preconditions which are one step closer to practical use than Example A-1.

First, as in Example A-1, for VMs of the same type, the condition is that the CPU usage time (CPU usage rate) and power consumption during use by the VM are linear. Furthermore, in Example A-2, there is power consumption of constant use due to using fans or the like in the server, regardless of the CPU usage rate. Thus, a condition in which each relational expression includes steady power consumption is set.

The power consumption calculation part 120 prepares a plurality of relational expressions using the CPU usage rates of the host OS and VM on the basis of these conditions and calculates the power consumption.

The information acquisition part 110 acquires the power consumption of the server and the CPU usage rate of the host and each VM from each of the plurality of target servers and the power consumption calculation part 120 creates the following relational expression for each server.

$${CPU}_{HOST} \% \times {U}_{HOST} + {CPU}_{A} \% \times {U}_{A} + {CPU}_{B} \% \times {U}_{B} + steady power consumption = P \qquad ( W )$$

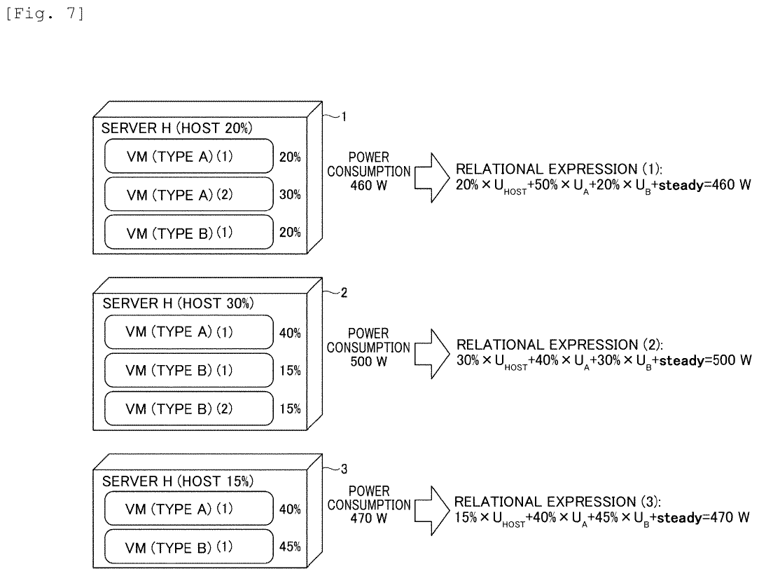

In the states of servers H1 to H3 shown in FIG. 7, the following three relational expressions are created as shown in FIG. 7. Note that steady power consumption is described as “steady”.

$$Relational expression ( 1 ) : 20 \% {U}_{HOST} + 50 \% \times {U}_{A} + 20 \% \times {U}_{B} + steady = 460 \qquad ( W )$$

$$Relational expression ( 2 ) : 30 \% {U}_{HOST} + 40 \% \times {U}_{A} + 30 \% \times {U}_{B} + steady = 500 \qquad ( W )$$

$$Relational expression ( 3 ) : 15 \% {U}_{HOST} + 40 \% \times {U}_{A} + 45 \% \times {U}_{B} + steady = 470 \qquad ( W )$$

The power consumption calculation part 120 solves the above three relational expressions as simultaneous expressions to calculate the U_{HOST}, the U_{A}, the U_{B}, and the steady power consumption.

### Example A-3

Example A-3 relating to power calculation for a plurality servers with the same specifications will be described. Example A-3 uses preconditions which are one step closer to practical use than Example A-2. In Example A-3, in addition to the preconditions described in Example A-2, a condition in which each relational expression includes an error is set.

The power consumption calculation part 120 prepares a plurality of relational expressions using the CPU usage rates of the host OS and VM and calculates the power consumption on the basis of these conditions.

The information acquisition part 110 acquires the power consumption of the server and the CPU usage rate of the host and each VM from each of the plurality of target servers and the power consumption calculation part 120 creates the following relational expression for each server.

$${CPU}_{HOST} \% \times {U}_{HOST} + {CPU}_{A} \% \times {U}_{A} + {CPU}_{B} \% \times {U}_{B} + steady power consumption + error = P \qquad ( W )$$

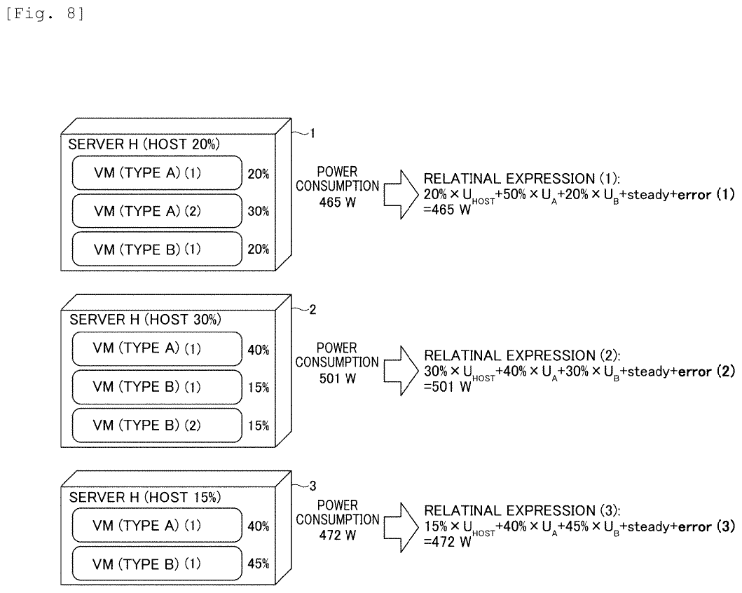

In the state of the servers H1 to H3 shown in FIG. 8, the following three relational expressions are created as shown in FIG. 8.

$$Relational expression ( 1 ) : 20 \% {U}_{HOST} + 50 \% \times {U}_{A} + 20 \% \times {U}_{B} + steady + error ( 1 ) = 465 \qquad ( W )$$

$$Relational expression ( 2 ) : 30 \% {U}_{HOST} + 40 \% \times {U}_{A} + 30 \% \times {U}_{B} + steady + error ( 2 ) = 501 \qquad ( W )$$

$$Relational expression ( 3 ) : 15 \% {U}_{HOST} + 40 \% \times {U}_{A} + 45 \% \times {U}_{B} + steady + error ( 3 ) = 472 \qquad ( W )$$

The power consumption calculation part 120 solves the three relational expressions to calculate the U_{HOST}, the U_{A}, the U_{B}, and the steady power consumption so that |error (1)|+|error (2)|+|error (3)| is the minimum. Specifically, the power consumption calculation part 120 calculates the U_{HOST}, the U_{A}, the Up, and the steady power consumption through linear programming using the following objective function and relational expressions (1) to (3) as constraint expressions. Note that using linear programming as a solution method is one example and the solution method is not limited to linear programming. For example, a technique such as multiple regression analysis may be used.

$$Objective function : minimize : \vert error ( 1 ) \vert + \vert error ( 2 ) \vert + \vert error ( 3 ) \vert$$

### Example B-1

Embodiment B-1 relating to power consumption calculation based on data at a plurality of times acquired at different times from the same server will be described. Note that, although Embodiment B is assumed to be implemented in a case in which a plurality of servers cannot be prepared as in Embodiment A, the present invention is not limited thereto. Embodiment B may be implemented even if a plurality of servers may be prepared. Furthermore, Example A and Example B may be combined and implemented.

In Example B-1, the information acquisition part 110 calculates the power consumption by acquiring the power consumption and the CPU usage rate from the same server at a plurality of different times and performs the same calculation as in a case in which there are a plurality of servers.

In Example B-1, the power consumption of each VM can be calculated using the same calculation as described in Example A (Examples A-1 to A-3) by considering a plurality of pieces of data acquired from the same server at a plurality of times as a plurality of pieces of data acquired from a plurality of servers in Example A.

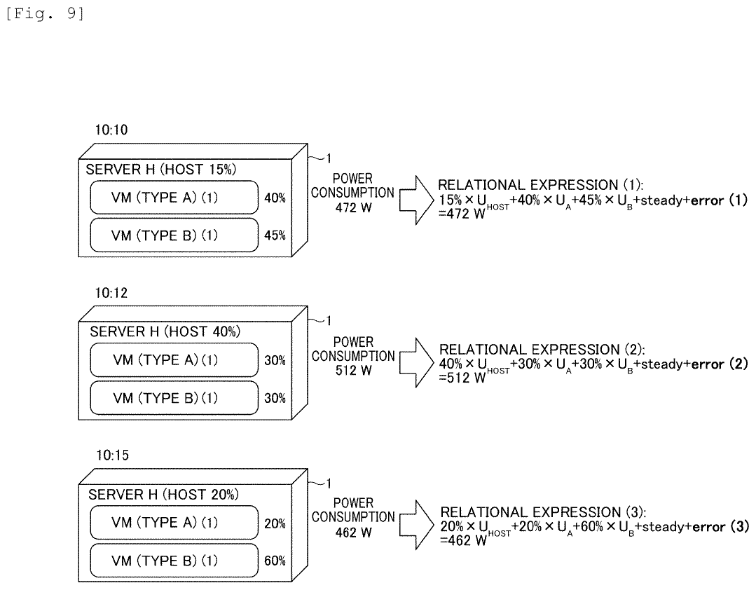

FIG. 9 shows an example based on the conditions and calculation method described in Example A-3. In this example, the information acquisition part 110 acquires the power consumption of the server and the CPU usage rate of the host and each VM from the same server H1 at 10:10, 10:12, and 10:15, respectively and the power consumption calculation part 120 creates the following relational expression for each time.

$$Relational expression ( 1 ) : 15 \% {U}_{HOST} + 40 \% \times {U}_{A} + 45 \% \times {U}_{B} + steady + error ( 1 ) = 472 \qquad ( W )$$

$$Relational expression ( 2 ) : 40 \% {U}_{HOST} + 30 \% \times {U}_{A} + 30 \% \times {U}_{B} + steady + error ( 2 ) = 512 \qquad ( W )$$

$$Relational expression ( 3 ) : 20 \% {U}_{HOST} + 20 \% \times {U}_{A} + 60 \% \times {U}_{B} + steady + error ( 3 ) = 462 \qquad ( W )$$

The power consumption calculation part 120 solves the three relational expressions to calculate the U_{HOST}, the U_{A}, the U_{B}, and the steady power consumption so that |error (1)|+|error (2)|+|error (3)| is the minimum. Specifically, the power consumption calculation part 120 calculates the U_{HOST}, the U_{A}, the U_{B}, and the steady power consumption through linear programming using the following objective function and relational expressions (1) to (3) as constraint expressions. Note that using linear programming as a solution method is one example and the solution method is not limited to linear programming. For example, a technique such as a plurality of regression analysis may be used.

$$Objective function : minimize : \vert error ( 1 ) \vert + \vert error ( 2 ) \vert + \vert error ( 3 ) \vert$$

### Example B-2

Embodiment B-2 relating to power consumption calculation based on data obtained at the plurality of times from the same server at different times will be described.

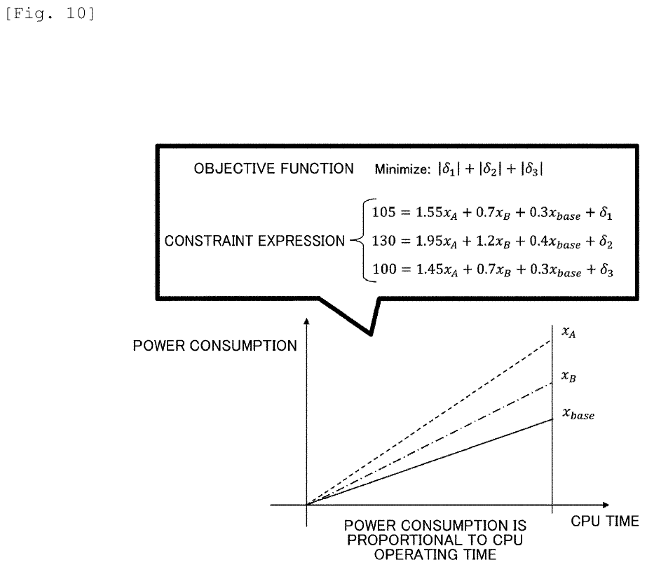

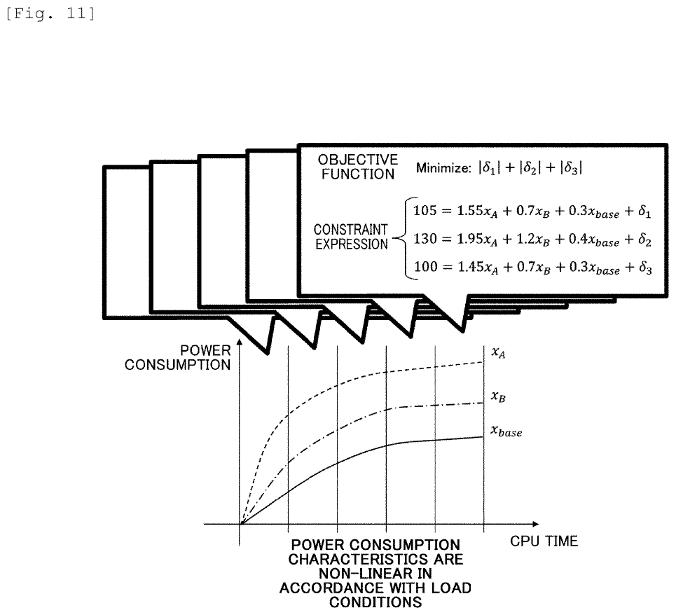

In the models of Example A-1 to Example B-1 explained described above, if it is a VM of the same type, although it is assumed that the CPU usage time (CPU usage rate) and power consumption used by the host and VM were linear, in B-2, this relationship is assumed to be nonlinear. FIG. 10 shows an example in which linearity is assumed and FIG. 11 shows an example in which nonlinearity is assumed.

As shown in FIG. 11, when it is assumed that the relationship between CPU usage time (CPU usage rate) and power consumption is non-linear, the power consumption calculation part 120 sub-divides the sections on the basis of the CPU usage time (CPU usage rate) and solves the simultaneous expressions independently for each section. That is to say, calculations are performed assuming that the power consumption characteristics in the subdivided sections are linear.

For example, for simplicity, it is assumed that the CPU usage rate (%) of the entire server was divided into three sections: 0 to 30 (Section 1), 30 to 70 (Section 2), and 70 to 100 (Section 3). The information acquisition part 110 acquires data over a plurality of times from the same server and divides the data into Section 1, Section 2, and Section 3, respectively. The power consumption calculation part 120 calculates the power consumption per 1% CPU usage rate of the host and each VM in each section, for example, using the method described in Example B-1.

When calculating power consumption using the measured value of CPU usage rate and power consumption per 1% CPU usage rate, calculation is performed in accordance with the above interval. For example, when the measurement value is a CPU usage rate which corresponds to Section 1, the power consumption is calculated using the power consumption per 1% CPU usage rate calculated in Section 1. The same applies to other sections.

### Example C

Although the relational expression is created using the CPU usage rate in Examples A and B explained above, even when using memory usage rate and disk usage rate other than CPU usage rate, basically, the power consumption of a VM can be calculated by creating a plurality of relational expressions using the same concept and solving the plurality of relational expressions.

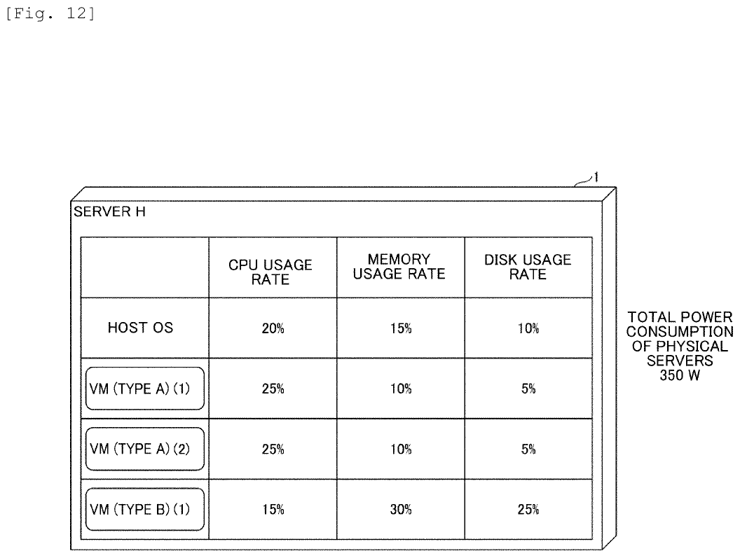

For example, the information acquisition part 110 acquires the data shown in FIG. 12 for each of the host, the VM (type A) (1), the VM (type A) (2), and the VM (type B) (1) from the server H1.

When the target is X, the coefficient representing the power consumption per 1% CPU usage rate of X is expressed as UX, the coefficient representing the power consumption per 1% memory usage rate of X is expressed as MX, and the coefficient representing the power consumption per 1% disk usage rate of X is expressed as DX. In this case, the power consumption calculation part 120 creates the following relational expression as a relational expression for the data shown in FIG. 12.

$$20 \% {U}_{HOST} + 50 \% \times {U}_{A} + 20 \% \times {U}_{B} + 15 \% \times {M}_{host} + 20 \% \times {M}_{A} + 30 \% \times {M}_{B} + 10 \% \times {D}_{host} + 10 \% \times {D}_{A} + 25 \% \times {D}_{B} + steady power consumption + error = 350 W$$

In the above expression, “20%×U_{HOST}+50%×U_{A}+15%×U_{B}” is a part relating to the CPU usage, “15%×Mₕₒₛₜ+20%×M_{A}+30%×M_{B}” is a part relating to the memory usage, and “10%×Uₕₒₛₜ+10%×D_{A}+25%×D_{B}” is a part relating to the disk usage rate.

If the calculation is based on Example A, the power consumption of the VM is calculated by creating and solving the above expression for a plurality of servers. If the calculation is based on Example B, the power consumption of the VM is calculated by creating and solving the above expression for a plurality of times.

### (S2: Future Power Consumption Prediction Processing on Movement Destination Server)

The process of predicting VM power consumption at the movement destination server performed using the power consumption prediction part 130 will be described below.

### <Overall Processing Flow>

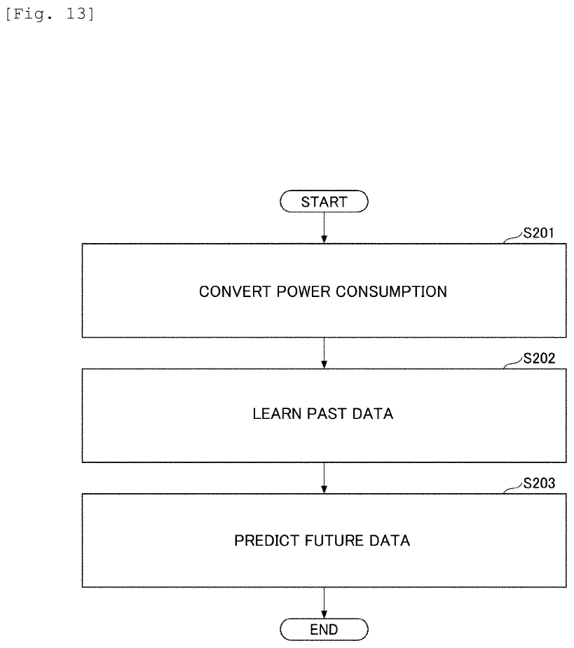

The overall process flow in S2 will be explained with reference to FIG. 13. At this point of time, it is assumed that the VM power consumption calculated on the basis of the power consumption of each VM per resource unit usage rate (for example, 1% CPU usage rate) calculated in S1 is stored in the data storage part 150 in the form of time series data.

In S201, the power consumption prediction part 130 converts the power consumption of each VM at each time into the power consumption when the VM is operated on a server different from the movement source server. As will be described later, in this embodiment, the power consumption is converted using the SERT value of the server and the converted power consumption is stored in the data storage part 150.

In S202, the power consumption prediction part 130 performs learning using past data accumulated in the data storage part 150.

In S203, the power consumption prediction part 130 predicts the future power consumption of the VM on the basis of the learning result in S202.

### (Details of Conversion Processing in S201)

As described above, in this embodiment, the SERT value is used as an index for converting the power consumption of a VM in a certain server to the power consumption in another server.

The SERT value is a value indicating energy consumption efficiency based on the Energy Saving Act and the SERT value is determined as a specification or the like for each server. The lower the SERT value, the better the energy consumption efficiency. Using this SERT value, the energy consumption efficiency of the movement source server and the movement destination server of the VM is compared and conversion is performed.

Specifically, the power consumption prediction part 130 converts the power consumption at the movement source server into the power consumption at the movement destination server using the following expression.

$$Power consumption on movement destination server = power consumption on source server \times ( SERT value on movement destination server ) / ( SERT value on movement source server )$$

When the SERT value of the movement source server is 12.3, the SERT value of the movement destination server is 14.2, and the power consumption of the VM on the movement source server is 100 W, the power consumption of the VM on the movement destination server=100 W×14.2/12.3=116 W.

The power consumption prediction process at the movement destination server of the VM will be described below in more detail using an example.

### (Example of Data Accumulation Method)

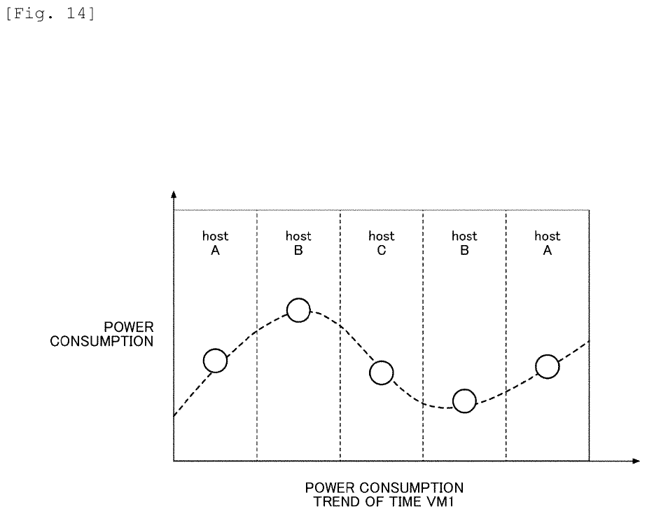

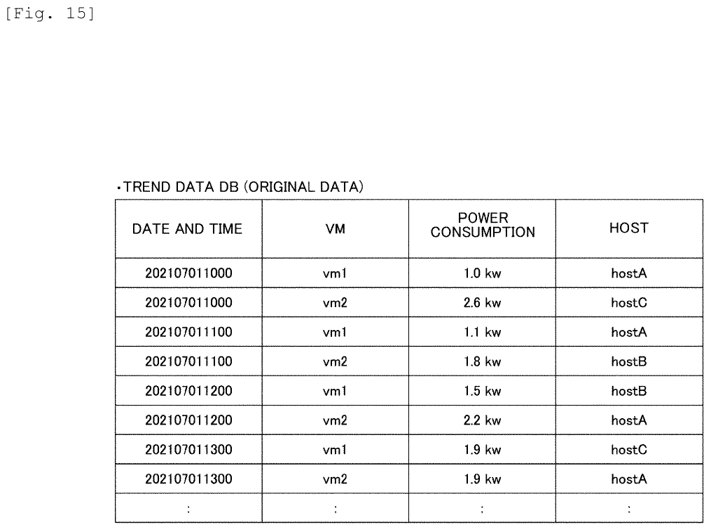

The power consumption behavior of VMs differs in accordance with the server in which the VM is installed. Thus, when accumulating the calculation results of VM power consumption in the data storage part 150, in addition to power consumption information, a host (a “host” may also be called a “server”) from which the calculation result is obtained is stored. FIG. 14 shows the power consumption trends of hosts A to B of the VM1. FIG. 15 shows an example of power consumption data (trend data DB) accumulated in the data storage part 150.

For example, the data “202107011000 vml 1.0 kw host A” in the first line of FIG. 15 means that the value calculated from the resource usage rate (for example, CPU usage rate) of the VM1 obtained from the host A server at time 202107011000 and the power consumption per resource unit usage rate calculated in S1 is 1.0 kw.

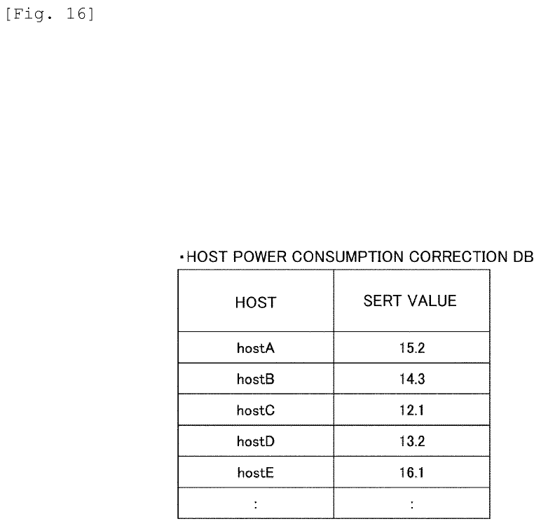

Also, in addition to the above data, SERT values for correcting the power consumption of each server are stored in the data storage part 150 as a host power consumption correction DB. FIG. 16 shows an example of the host power consumption correction DB.

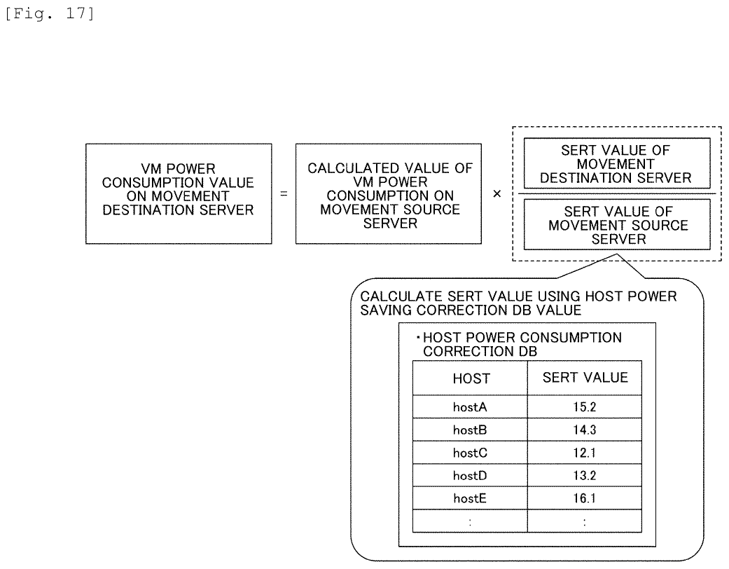

Subsequently, as shown in FIG. 17, the power consumption prediction part 130 calculates the power consumption of the VM at the movement destination server using the calculation expression using the SERT value described above and accumulates the calculation result in the data storage part 150 (trend data DB).

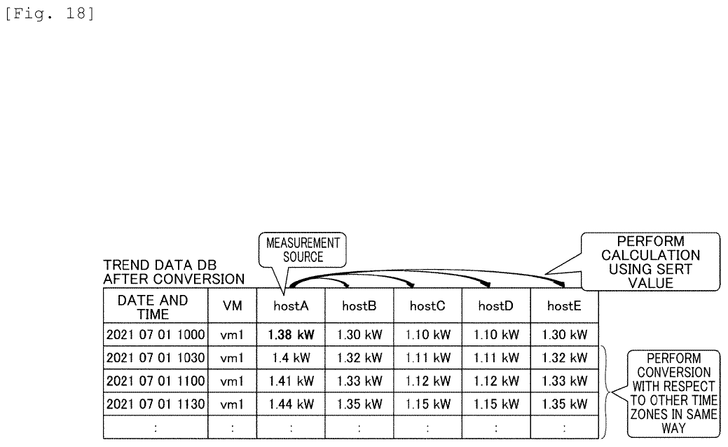

FIG. 18 shows an example of a trend data DB which includes data obtained by converting the original power consumption into the power consumption of the VM on the movement destination server. For example, the first line of the data in FIG. 18, “202107011000 vml 1.38 kw 1.30 kW . . . ” means that the value calculated from the resource usage rate of VM1 obtained from the server of the host A and the power consumption per resource unit usage rate calculated in S1 is 1.38 kw and the value converted into the power consumption of the server of the host B is 1.30 kW. The same applies to other servers and other time zones.

### (Learning/Prediction Method of S202 and S203)

An example of a learning method and a prediction method using a trend data DB in which data is accumulated as described above will be explained below.

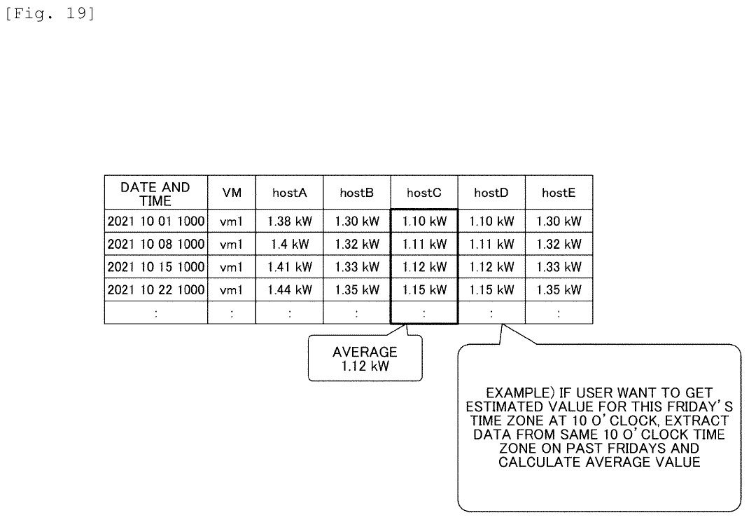

For example, it is assumed that a user would like to obtain the predicted power consumption of VM1 on host C (server) this Tuesday at 10 o'clock this Friday. In this case, as shown in FIG. 19, the power consumption prediction part 130 extracts data of the VM1 on the host C during the 10 o'clock time period on past Fridays by searching the trend data DB and calculates the average value of the extracted data to obtain a prediction value for the 10 o'clock time slot on Friday of this week. Prediction values can be obtained for other servers and other dates and times using the same method.

Note that the method for obtaining the prediction value is not limited to the above method. For example, the prediction value may be calculated using machine learning.

For example, the date and time, the VM, and the host in the trend data DB are used as inputs to the neural network and the neural network is learned so that the output from the neural network becomes the correct power consumption in the trend data DB. The power consumption prediction part 130 includes the learned neural network, inputs “future date/time, VM, host” whose power consumption is desired to be known to the neural network, and uses an output as a prediction value of power consumption.

### (Macro Load Trend of Group of VMs of Same Type)

Here, a method for predicting the future CPU usage rate of each VM using macro load changes of a group of homogeneous VMs will be explained. If the CPU usage rate is predicted, a future power consumption is predicted by using the power consumption per unit CPU usage rate. Furthermore, although the method which will be described below has, a target, for example, the CPU usage rate, the method which will be described below can also be applied to other resource usage rates, VM power consumption, and the like.

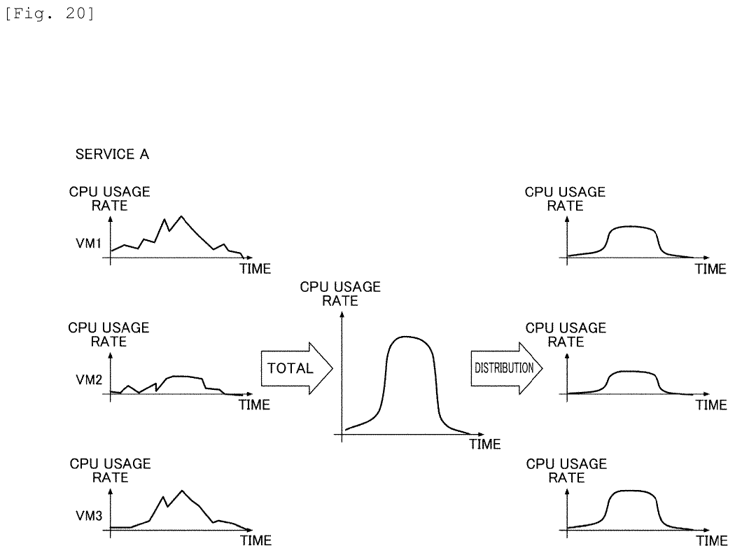

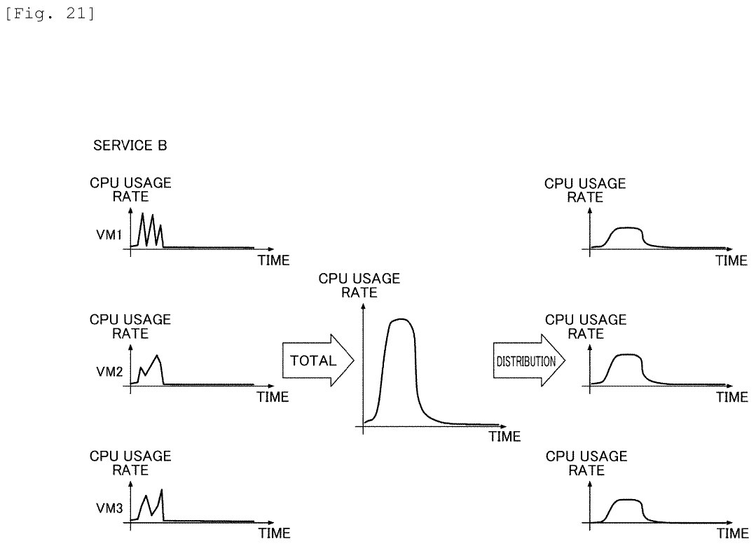

Generally, the CPU usage rate of individual VMs fluctuates widely and is difficult to predict accurately. On the other hand, since the same type of services have similar usage trends, there is also a correlation in CPU usage. This is shown in the left side view of FIG. 20 and the left side view of FIG. 21. That is to say, the left side diagram of FIG. 20 shows the time-series trends in the CPU usage rates of VMs 1 to 3 which provide Service A, and as shown, the time-series trends in VMs 1 to 3 are similar. Similarly, as shown in the left side diagram of FIG. 21, the time-series trends in VMs 1 to 3 that provide service B are similar.

“Similar services” may be services that have any relationship as long as they have similar trends in resource usage rates over time. For example, when providing the same application using a plurality of VMs in Japan, it is said that the plurality of VMs providing the application can be VMs of the same type of service.

Thus, the power consumption prediction part 130 adds up the CPU usage rates of the plurality of VMs of the same type of service. As a result, as shown in the center diagram of FIG. 20 and the center diagram of FIG. 21, time-series fluctuations are stabilized and existing prediction techniques (regression analysis and the like) can be applied.

The power consumption prediction part 130 uses the data of the CPU usage rates summed up as described above to predict the future of the summed CPU usage rates through regression analysis or the like.

Subsequently, the power consumption prediction part 130 calculates the predicted value of the CPU usage rate of each VM by distributing the CPU usage rate trend predicted by the total value using a weighted average based on the total sum of the original CPU usage rates. Images of the distribution are shown in the right-hand diagram of FIG. 20 and the right-hand diagram of FIG. 21. It is possible to calculate the prediction value of the power consumption of each VM by using the prediction value of the CPU usage rate of each VM and the power consumption per 1% CPU usage rate of each VM.

The calculation method performed using the power consumption prediction part 130 will be described in more detail below.

It is assumed that the information acquisition part 110 collects the CPU usage rate of each VM in a certain time interval (every 5 minutes). The collected data is stored in the data storage part 150.

At this time, the CPU usage rate at time t in each VMi (i=1 to n) regarding a certain service A is expressed as x^{A}_{i,t}. At this time, the summation operation shown in the center diagrams of FIGS. 20 and 21 can be performed using the following expression.

$${x}_{t}^{A} = {\sum }_{i = 1}^{n} {x}_{i , t}^{A} \qquad [ Math . 1 ]$$

Furthermore, a prediction value (t>τ) based on past performance data of x^{A}ₜ (t≤τ, where τ is a current time) is expressed as \hat{ }x^{A}ₜ. Note that the “\hat{ }” at the beginning of x which indicates that variable x is a prediction value is written before variable x in the text of the specification for convenience of description.

Similarly, the prediction value of VMi regarding Service A is expressed as \hat{ }x^{A}_{i,t}. At this time, the distribution operation shown in FIGS. 20 and 21 is provided through the following expression by providing the weight of VMi regarding Service A as

$${w}_{i}^{A} = {\sum }_{t = t 1}^{t 2} {x}_{i , t}^{A} \qquad [ Math . 2 ]$$

$${\hat{x}}_{i , t}^{A} = \frac{{w}_{i}^{A}}{{\sum }_{j = 1}^{n} {w}_{j}^{A}} {\hat{x}}_{t}^{A} \qquad [ Math . 3 ]$$

Note that t1 and t2 (t2>t1) are parameters which specify the target period of performance data to be considered for weighting and can be arbitrarily determined. For example, it can be set for the past 24 hours or the past several days.

### Hardware Configuration Example

The virtual machine power consumption prediction device 100 can be realized, for example, by causing a computer to execute a program. This computer may be a physical computer or a virtual machine on the cloud.

That is to say, the virtual machine power consumption prediction device 100 can be realized by executing a program corresponding to the processing performed by the virtual machine power consumption prediction device 100 using hardware resources such as the CPU and memory built into the computer. The above program can be recorded on a computer-readable recording medium (such as a portable memory) and can be stored or distributed. It is also possible to provide the above program through a network such as the Internet or an e-mail.

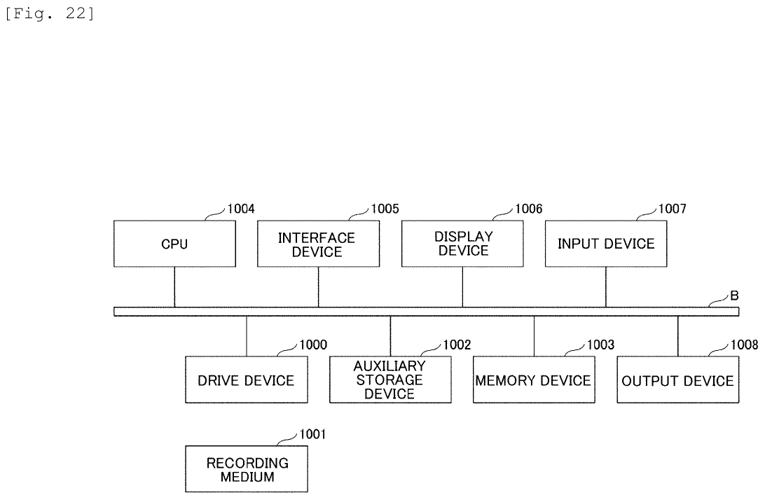

FIG. 22 is a diagram showing an example of a hardware configuration of the computer. The computer in FIG. 22 includes a drive device 1000, an auxiliary storage device 1002, a memory device 1003, a CPU 1004, an interface device 1005, a display device 1006, an input device 1007, an output device 1008, and the like which are interconnected by a bus BS.

A program for realizing processing using the computer is provided by, for example, a recording medium 1001 such as a CD-ROM or a memory card. If the recording medium 1001 storing the program is set in the drive device 1000, the program is installed from the recording medium 1001 to the auxiliary storage device 1002 via the drive device 1000. Here, the program does not necessarily need to be installed from the recording medium 1001 and may be downloaded from another computer over a network The auxiliary storage device 1002 stores installed programs as well as necessary files, data, and the like.

The memory device 1003 reads the program from the auxiliary storage device 1002 and stores it when there is an instruction to start the program. The CPU 1004 implements functions relating to the virtual machine power consumption prediction device 100 according to programs stored in the memory device 1003. The interface device 1005 is used as an interface for connecting to a network or the like. A display device 1006 displays a graphical user interface (GUI) or the like using a program. The input device 1007 is composed of a keyboard, a mouse, buttons, a touch panel, and the like and is used for inputting various operation instructions. The output device 1008 outputs the calculation result.

### Effects of Embodiments

With the technique according to this embodiments, it is possible to appropriately predict the power consumption of a virtual machine when the virtual machine is moved from a movement source server to a movement destination server.

### Supplement Notes

This specification discloses at least the following virtual machine power consumption prediction device, virtual machine power consumption prediction method, and program.

### (Item 1)

A virtual machine power consumption prediction device, including:
a power consumption calculation part which calculates power consumption of a virtual machine running on a first server on the basis of a resource usage state on the first server; and
a power consumption prediction part which predicts power consumption of the virtual machine when the virtual machine is moved to a second server on the basis of an index indicating energy consumption efficiency of each of the first server and the second server.

### (Item 2)

The virtual machine power consumption prediction device according to item 1, wherein the power consumption calculation part prepares, for each of the plurality of servers, a relational expression indicating a relationship between the power consumption of the server and the total power consumption of a host and each virtual machine running on the server and calculates the power consumption using a plurality of relational expressions of the plurality of servers.

### (Item 3)

The virtual machine power consumption prediction device according to item 1, wherein the power consumption calculation part prepares, for each of a plurality of times in one server, a relational expression indicating a relationship between the power consumption of the server and the sum of the power consumption of the host and each virtual machine running on the server and calculates the power consumption using a plurality of relational expressions at the plurality of times.

### (Item 4)

The virtual machine power consumption prediction device according to item 2 or 3, wherein a total power consumption of the host and each virtual machine in the relational expression is a sum of a value obtained by multiplying a measurement value of a resource usage rate of the host by a variable indicating the power consumption per unit resource usage rate of the host and a total of all virtual machines of a value obtained by multiplying a measurement value of a resource usage rate of the virtual machine by a variable indicating the power consumption per unit resource usage rate of the virtual machine.

### (Item 5)

The virtual machine power consumption prediction device according to any one of items 1 to 4, wherein the power consumption prediction part predicts a future power consumption of the virtual machine using accumulated data of time-series power consumption of the virtual machine.

### (Item 6)

The virtual machine power consumption prediction device according to any one of items 1 to 4, wherein the power consumption prediction part adds up time series data of resource usage rates for a plurality of virtual machines in the same type of service across the plurality of virtual machines, predicts a future resource usage rate for the combined resource usage rate, calculates a future resource usage rate of each virtual machine by distributing the future resource usage rate to the plurality of virtual machines, and predicts a future power consumption of each virtual machine using the future resource usage rate.

### (Item 7)

A virtual machine power consumption prediction method performed by a virtual machine power consumption prediction device, including:
a power consumption calculation step of calculating power consumption of a virtual machine running on a first server on the basis of a resource usage state on the first server; and
a power consumption prediction step of predicting power consumption of the virtual machine when the virtual machine is moved to a second server on the basis of an index indicating energy consumption efficiency of each of the first server and the second server.

### (Item 8)

A program causing a computer to function as each part of the virtual machine power consumption prediction device according to any one of items 1 to 6.

### (Item 9)

A non-transitory storage medium which stores a program causing a computer processor to execute:
a power consumption calculation process of calculating power consumption of a virtual machine running on a first server on the basis of a resource usage state on the first server; and
a power consumption prediction process of predicting power consumption of the virtual machine when the virtual machine is moved to a second server on the basis of an index indicating energy consumption efficiency of each of the first server and the second server.

Although this embodiment has been described above, the present invention is not limited to such specific embodiments, and various modifications and changes can be provided within the scope of the gist of the present invention as described in the claims.

### REFERENCE SIGNS LIST

100 Virtual machine power consumption prediction device
110 Information acquisition part
120 Power consumption calculation part
130 Power consumption prediction part
140 Output part
150 Data storage part
200 Physical network
1000 Drive device
1001 Recording medium
1002 Auxiliary storage device
1003 Memory device
1004 CPU
1005 Interface device
1006 Display device
1007 Input device
1008 Output device

1. A virtual machine power consumption prediction device, comprising:
a memory; and
a processor coupled to the memory and configured to:
calculate power consumption of a virtual machine running on a first server on the basis of a resource usage state on the first server; and
predict power consumption of the virtual machine when the virtual machine is moved to a second server on the basis of an index indicating energy consumption efficiency of each of the first server and the second server.

2. The virtual machine power consumption prediction device according to claim 1, wherein the processor is configured to prepare, for each of the plurality of servers, a relational expression indicating a relationship between the power consumption of the server and the total power consumption of a host and each virtual machine running on the server and calculate the power consumption using a plurality of relational expressions of the plurality of servers.

3. The virtual machine power consumption prediction device according to claim 1, wherein the processor is configured to prepare, for each of a plurality of times in one server, a relational expression indicating a relationship between the power consumption of the server and the sum of the power consumption of the host and each virtual machine running on the server and calculate the power consumption using a plurality of relational expressions at the plurality of times.

4. The virtual machine power consumption prediction device according to claim 2, wherein a total power consumption of the host and each virtual machine in the relational expression is a sum of a value obtained by multiplying a measurement value of a resource usage rate of the host by a variable indicating the power consumption per unit resource usage rate of the host and a total of all virtual machines of a value obtained by multiplying a measurement value of a resource usage rate of the virtual machine by a variable indicating the power consumption per unit resource usage rate of the virtual machine.

5. The virtual machine power consumption prediction device according to claim 1, wherein the processor is configured to predict a future power consumption of the virtual machine using accumulated data of time-series power consumption of the virtual machine.

6. The virtual machine power consumption prediction device according to claim 1, wherein the processor is configured to add up time series data of resource usage rates for a plurality of virtual machines in the same type of service across the plurality of virtual machines, predict a future resource usage rate for the combined resource usage rate, calculate a future resource usage rate of each virtual machine by distributing the future resource usage rate to the plurality of virtual machines, and predict a future power consumption of each virtual machine using the future resource usage rate.

7. A virtual machine power consumption prediction method performed by a virtual machine power consumption prediction device, comprising:
calculating power consumption of a virtual machine running on a first server on the basis of a resource usage state on the first server; and
predicting power consumption of the virtual machine when the virtual machine is moved to a second server on the basis of an index indicating energy consumption efficiency of each of the first server and the second server.

8. A non-transitory computer-readable recording medium storing a program causing a computer to perform the method of claim 7.
